(19) United States
(12) Patent Application Publication
(10) Pub. No.: US 2013/0178235 A1
(43) Pub. Date: Jul. 11, 2013

(54) Wireless Communication Positioning Method

(71) Applicants: Chien-Sheng Chen, Kaohsiung City (TW); Yung-Chuan Lin, Hsinchu City (TW)

(72) Inventors: Chien-Sheng Chen, Kaohsiung City (TW); Yung-Chuan Lin, Hsinchu City (TW)

(21) Appl. No.: 13/447,278

(22) Filed: Apr. 15, 2012

(30) Foreign Application Priority Data
Jan. 6, 2012 (TW) 101100537

(51) Int. Cl. H04W 24/00

(52) U.S. Cl. 455/456.5

(57) ABSTRACT

A wireless communication positioning method is disclosed for obtaining an estimated position of a mobile device. The wireless communication positioning method includes obtaining an angle of arrival for the mobile device relative to one of a plurality of base stations and obtaining a line of arrival angle extended along the angle of arrival from the one of the plurality of base stations, obtaining a plurality of measured distances of the plurality of base stations relative to the mobile device and obtaining a plurality of measured circles corresponding to the plurality of measured distances, generating a plurality of position lines according to the plurality of measured circles, and calculating the estimated position of the mobile device according to the plurality of position lines and the line of arrival angle.

### BACKGROUND OF THE INVENTION

1. Field of the Invention

The present invention relates to a wireless communication positioning method, and more particularly, to a wireless communication positioning method for obtaining an estimated position of a mobile device.

2. Description of the Prior Art

In the development of the wireless communication, the prior art has provided plenty of algorithms of wireless positioning to estimate a position of a mobile device according to at least one base station for measuring the time point of arrival (TOA), the angle of arrival (AOA), the signal strength (SS) and time difference of arrival (TDOA) of the mobile device. Wireless positioning is limited by conditions of the propagation environment, such as noises in propagation channels, multi-path propagation, multiple access interferences and line-of-sight (LOS) blockages, and cannot accurately measure the LOS between the mobile device and the base stations and suffers from unnecessary refraction or diffraction. In other words, non-line-of-sight (NLOS) distance can dramatically influence the accuracy of the wireless positioning.

In the prior art, a plurality of base stations are utilized to respectively measure the TOA of a feedback signal corresponding to the mobile device and generate a plurality of circle formulas. Next, the plurality of circle formulas input the Taylor series algorithm to calculate intersectional points of the plurality of circle formulas. However, these intersectional points come from non-linear functions and longer calculating periods are needed in order to estimate the position of the mobile device via iterations, which limits the practical applications and causes waste of calculating periods or hardware resources.

### SUMMARY OF THE INVENTION

A wireless communication positioning method is provided, which can effectively reduce the calculating complexity and save calculating periods.

According to an aspect of the disclosure, a wireless communication positioning method is provided for obtaining an estimated position of a mobile device. The wireless communication positioning method includes obtaining an angle of arrival for the mobile device relative to one of a plurality of base stations and obtaining a line of arrival angle extended along the angle of arrival from the one of the plurality of base stations, obtaining a plurality of measured distances of the plurality of base stations relative to the mobile device and obtaining a plurality of measured circles corresponding to the plurality of measured distances, generating a plurality of position lines according to the plurality of measured circles, and calculating the estimated position of the mobile device according to the plurality of position lines and the line of arrival angle.

According to another aspect of the disclosure, a wireless communication positioning method is provided for obtaining an estimated position of a mobile device. The wireless communication positioning method includes obtaining a line of arrival angle which extends to pass through one of a plurality of base stations and the mobile device; obtaining a plurality of measured circles corresponding to the plurality of base stations, each of the measured circles is generated by a plurality of measured distances of the plurality of base stations relative to the mobile device; generating a plurality of position lines according to the plurality of measured circles; and calculating the estimated position of the mobile device according to the plurality of position lines and the line of arrival angle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a schematic diagram of a wireless communication positioning system according to an embodiment of the invention.

FIG. 1B illustrates a schematic diagram of a wireless communication positioning system according to another embodiment of the invention.

FIG. 2 illustrates a flow chart of a wireless communication positioning process applied to the wireless communication positioning system in FIG. 1A according to an embodiment of the invention.

FIG. 3 illustrates a flow chart of a distance-weighted process according to an embodiment of the invention.

FIG. 4 illustrates a flow chart of a sort-averaging process according to an embodiment of the invention.

FIG. 5 illustrates a flow chart of a sort-weighted process according to an embodiment of the invention.

FIG. 6 illustrates a flow chart of a threshold process according to an embodiment of the invention.

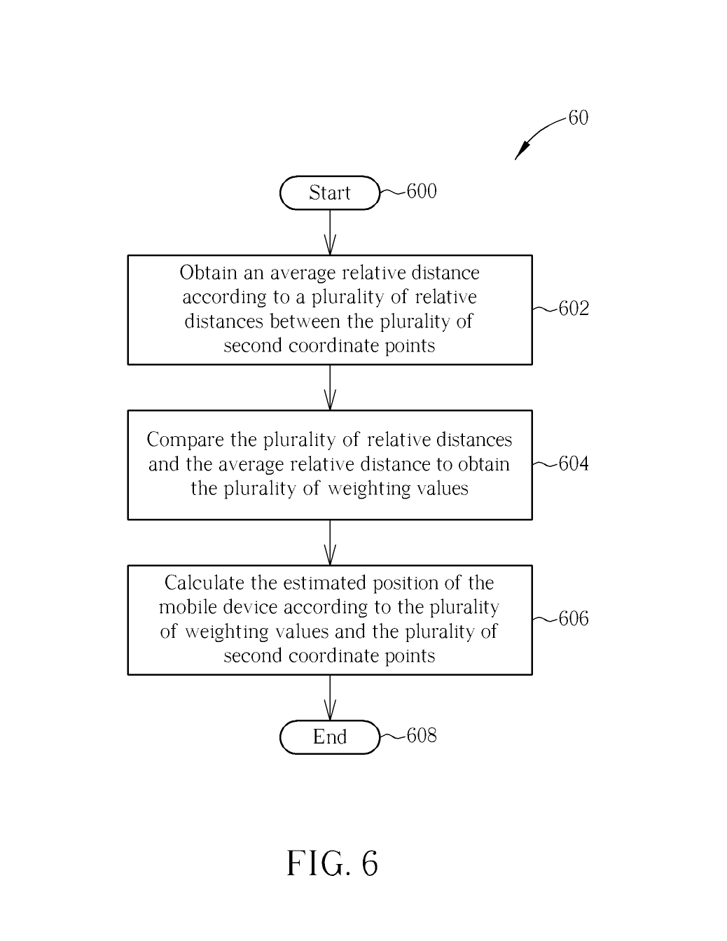

FIG. 7 illustrates a schematic diagram of the Cumulative Distribution Function where shows difference between the prior art and a simulatoin example of the invention in the CDSM.

FIG. 8 illustrates a schematic diagram of calculating periods between the prior art and a simulatoin example of the invention in the CDSM.

FIG. 9 illustrates a schematic diagram of root-mean-square estimated positions between the prior art and a simulatoin example of the invention in the CDSM.

FIG. 10 illustrates a schematic diagram of different ratio constants between the prior art and the invention in the distance dependent NLOS error model.

FIG. 11 illustrates a schematic diagram of the CDF with the ratio constants as 0.13 between the prior art and the invention in the distance dependent NLOS error model.

FIG. 12 illustrates a schematic diagram of different fixed ranges with upper bounds between the prior art and the invention in the normally distributed noise model.

FIG. 13 illustrates a schematic diagram of the CDF of the fixed range with upper bound between the prior art and the invention in the normally distributed noise model.

### DETAILED DESCRIPTION

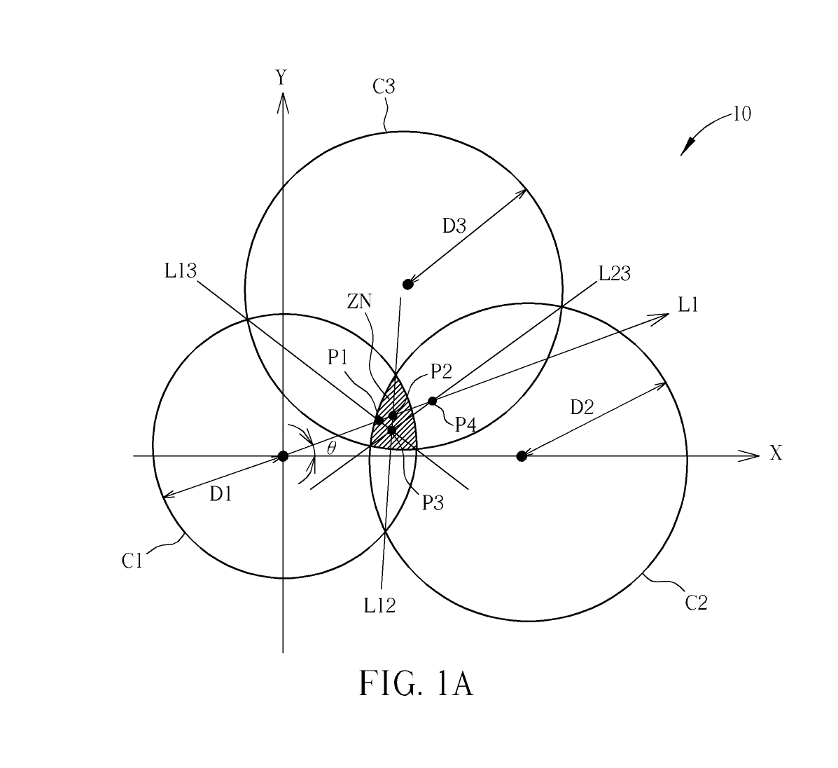

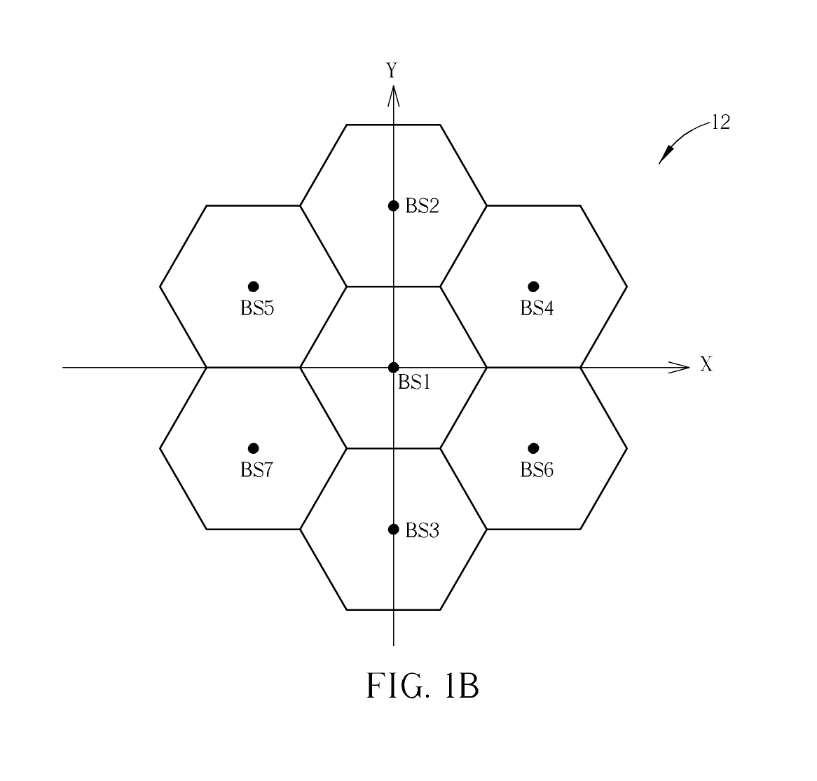

Please refer to FIG. 1A, which illustrates a schematic diagram of a wireless communication positioning system 10 according to an embodiment of the invention. In this embodiment, the wireless communication positioning system 10 includes three base stations BS1, BS2, BS3, and a mobile device (not shown in the figure). The base stations BS1, BS2 and BS3 are surrounding to the mobile device, and the base stations BS1 is the nearest one to the mobile device to be the so-called serving base station. Herein, the number of three is only for demonstration, and other practical numbers of base stations, like seven, are possible according to users' requirements. As shown in FIG. 1B, seven base stations BS1-BS7 also form another wireless communication positioning system 12, which is not to limit the scope of the invention.

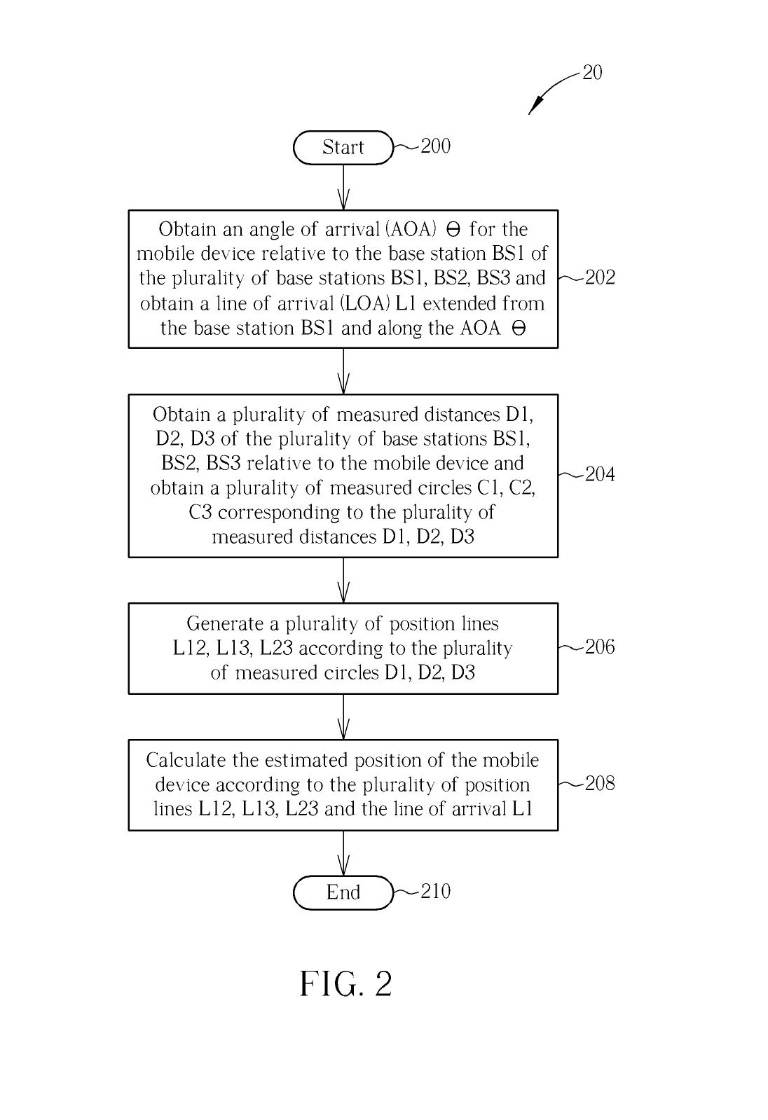

Please refer to FIG. 2, which illustrates a flow chart of a wireless communication positioning process 20 applicable to the wireless communication positioning system 10 shown in FIG. 1A according to an embodiment of the invention, so as to obtain an estimated position of the mobile device. The wireless communication positioning process 20 includes the steps as follows:

Step 200: Start.

Step 202: Obtain an angle of arrival (AOA) θ for the mobile device relative to the base station BS1 of the plurality of base stations BS1, BS2, BS3 and obtain a line of arrival angle (LOA) L1 extended from the base station BS1 and along the AOA e.

Step 204: Obtain a plurality of measured distances D1, D2, D3 of the plurality of base stations BS1, BS2, BS3 relative to the mobile device and obtain a plurality of measured circles C1, C2, C3 corresponding to the plurality of measured distances D1, D2, D3.

Step 206: Generate a plurality of position lines L12, L13, L23 according to the plurality of measured circles D1, D2, D3.

Step 208: Calculate the estimated position of the mobile device according to the plurality of position lines L12, L13, L23 and the line of arrival angle L1.

Step 210: End.

In the wireless communication positioning process 20, the base stations BS1, BS2, BS3 and the mobile device share signals with each other via wireless transmission. In other words, the base stations BS1, BS2, BS3 and the mobile device cooperate with each other in the wireless communication positioning process 20. In detail, each step can operate through any of the base stations BS1, BS2, BS3 or the mobile device. Or the base stations BS1, BS2, BS3 can initially be utilized for calculating partial information to be provided to the mobile device, which subsequently calculates other partial information. Finally, the mobile device and/or the base stations BS1, BS2, BS3 can calculate the estimated position of the mobile device.

First of all, in step 202, the AOA θ between the mobile device and the base station BS1 is measured. Then, the LOA L1 is formed, which extends from a starting point at the base station BS1 along two opposite directions, with a slope corresponding to the AOA. Preferably, the information of the AOA θ is calculated by the base station BS1 and provided to the mobile device. After the mobile device obtains the information of the AOA θ, the LOA L1 is calculated subsequently. Alternatively, both the AOA θ and the LOA L1 are calculated by the base station BS1, which then provides the LOA L1 to the mobile device.

In step 204, the three measured distances D1, D2, D3 relative to the three base stations BS1, BS2, BS3 are obtained, and the plurality of measured circles C1, C2, C3 are obtained according to the plurality of measured distances D1, D2, D3 as well. In detail, time points of arrival (TOAs) T1, T2, T3 between the three base stations BS1, BS2, BS3 and the mobile device are initially obtained, and the TOAs T1, T2, T3 are transformed into the measured distances D1, D2, D3, where the transformation can be performed by multiplying the TOAs T1, T2, T3 by a propagation speed of the wireless signal (i.e. the speed of light) to obtain the measured distances D1, D2, D3. Next, utilizing the base stations BS1, BS2, BS3 as centers of the circles and the measured distances D1, D2, D3 as diameters, three measured circles C1, C2, C3 are obtained corresponding to the base stations BS1, BS2, BS3. Preferably, the measured distances D1, D2, D3 and the measured circles C1, C2, C3 are individually calculated by the base stations BS1, BS2, BS3 and then provided to the mobile device. Or the base stations BS1, BS2, BS3 initially calculate part of the information, such as at least the TOAs T1, T2, T3, and then provide the calculated information to the mobile device to calculate the rest of the information, such as at least the measured circles C1, C2, C3.

In step 206, any two of the measured circles C1, C2, C3 forms two intersectional points to generate the position line, and accordingly, to form the three position lines L12, L13, L23 between the three measured circles C1, C2, C3. The information of the three position lines L12, L13, L23 can be calculated by the base stations BS1, BS2, BS3 and then provided to the mobile device, or it can be directly calculated by the mobile device.

In step 208, any two of the position lines L12, L13, L23 and the LOA L1 intersect to form a point, so as to generate first coordinate points P1, P2, P3, P4 accordingly. Next, the first coordinate points P1, P2, P3, P4 are utilized to obtain the estimated position of the mobile device. Preferably, a proper zone ZN are formed according to an intersection zone crossed by the measured circles C1, C2, C3, and the first coordinate points P1, P2, P3, P4 within the proper zone ZN are selected as second coordinate points P1, P2, P3 to exclude least possible coordinate points and to simplify the calculation by reducing number of the intersectional points. Next, the second coordinate points P1, P2, P3 input different algorithms, such as a distance-weighted method, a sort-averaging method, a sort-weighted method or a threshold method to calculate the estimated position of the mobile device. Step 208 is performed by the mobile device or the base stations BS1, BS2, BS3.

Noticeably, if there are no errors, the three position lines L12, L13, L23 can intersect at the same point, which is exactly the accurate position of the mobile device. However, due to the non-line-of-sight (NLOS) effect, there exist the first coordinate points located within a certain zone separately, which are not equal to the accurate position of the mobile device. Besides, when considering the NLOS effect, it is impossible to measure a real distance of the line-of-sight (LOS) distance according to the TOAs, i.e. the measured distances D1, D2, D3 must be larger than the real distances. Therefore, the user can expect that the accurate position of the mobile device will be located within the intersection zone (i.e. the proper zone ZN) of the measured circles C1, C2, C3. In other words, more accuracy to calculate the estimated position of the mobile device is provided by utilizing the second coordinate points P1, P2, P3 located within the proper zone ZN from the first coordinate points P1, P2, P3, P4.

From the above, according to the wireless communication positioning process 20, the information of the three position lines L12, L13, L23 and the LOA L1 are obtained, which are further utilized to calculate the estimated position of the mobile device. Additionally, during the calculating process, the proper zone is utilized to filter out improper intersectional points, and to increase accuracy or reduce calculations.

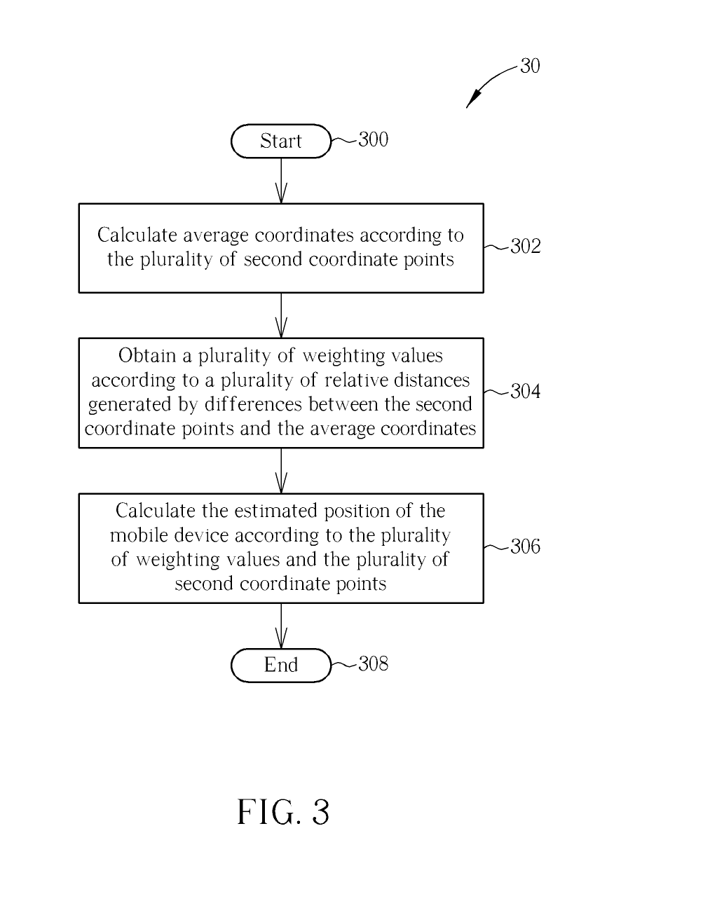

Furthermore, step 208 of calculating the estimated position of the mobile device according to the plurality of position lines L12, L13, L23 and the LOA L1 in the wireless communication positioning process 20 can be derived into another distance-weighted process 30 for calculating the estimated position of the mobile device. As shown in FIG. 3, the distance-weighted process 30 according to an embodiment of the invention includes the steps as follows:

Step 300: Start.

Step 302: Calculate average coordinates according to the plurality of second coordinate points.

Step 304: Obtain a plurality of weighting values according to a plurality of relative distances generated by differences between the second coordinate points and the average coordinates.

Step 306: Calculate the estimated position of the mobile device according to the plurality of weighting values and the plurality of second coordinate points.

Step 308: End.

First of all, the plurality of second coordinate points (i.e. the intersectional points P1, P2, P3 shown in FIG. 1A) located within the proper zone ZN from the wireless communication positioning process 20 are inputted the distance-weighted process 30. For convenience, the second coordinate points are simply called intersectional points. In the following formulas, the symbol N represents the total number of the intersectional points, the symbol I represents one of the intersectional points, and each of the intersectional points has a X-axis coordinate as well as a Y-axis coordinate.

As with the embodiment shown in FIG. 1A, N=3 and the plurality of intersectional points as P1 (X1, Y1)′ P2 (X2, Y2)′ P3 (X3, Y3). In step 302, the formula

$${\overline{x}}_{N} = \frac{1}{N} {\sum }_{i = 1}^{N} {x}_{i}$$

can be utilized to calculate an average X-axis coordinate value X̅_{N} of all the intersectional points and the formula

$${\overline{y}}_{N} = \frac{1}{N} {\sum }_{i = 1}^{N} {y}_{i}$$

can be utilized to calculate an average Y-axis coordinate value Y̅_{N} of all the intersectional points. In step 304, the formula dᵢ=\sqrt{(xᵢ− x̅_{N})²+(yᵢ− y̅_{N})²}, 1≦i≦N can be utilized to calculate weighting values d₁, d₂, d₃ corresponding to the intersectional points P1, P2, P3 respectively. In step 306, the formula

$${x}_{d} = \frac{{\sum }_{i = 1}^{N} {( {d}_{i}^{2} )}^{- 1} \cdot {x}_{i}}{{\sum }_{i = 1}^{N} {( {d}_{i}^{2} )}^{- 1}} and {y}_{d} = \frac{{\sum }_{i = 1}^{N} {( {d}_{i}^{2} )}^{- 1} \cdot {y}_{i}}{{\sum }_{i = 1}^{N} {( {d}_{i}^{2} )}^{- 1}}$$

can be utilized to calculate the estimated coordinate (X_{d}, Y_{d}) of the mobile device.

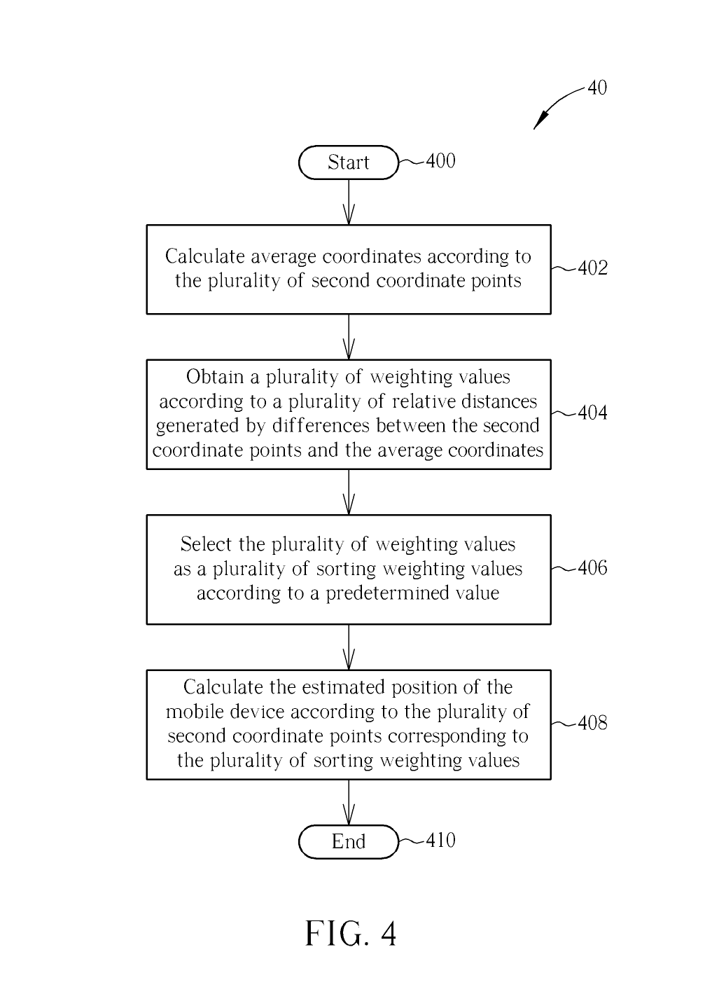

Moreover, step 208 of calculating the estimated position of the mobile device according to the plurality of position lines L12, L13, L23 and the LOA L1 in the wireless communication positioning process 20 can be derived into another sort-averaging process 40 for calculating the estimated position of the mobile device. As shown in FIG. 4, the sort-averaging process 40 according to an embodiment of the invention includes the steps as follows:

Step 400: Start.

Step 402: Calculate average coordinates according to the plurality of second coordinate points.

Step 404: Obtain a plurality of weighting values according to a plurality of relative distances generated by differences between the second coordinate points and the average coordinates.

Step 406: Select the plurality of weighting values as a plurality of sorting weighting values according to a predetermined value.

Step 408: Calculate the estimated position of the mobile device according to the plurality of second coordinate points corresponding to the plurality of sorting weighting values.

Step 410: End.

Noticeably, the sort-averaging process 40 is similar to the distance-weighted process 30, i.e. steps 402, 404 of the sort-averaging process 40 are the same as steps 302, 304 of the distance-weighted process 30. Thus, steps 402, 404 of the sort-averaging process 40 utilize the same description of the distance-weighted process 30, which is not described hereinafter. In step 406, the mentioned N weighting values are ascending sorted, where initial M sorting weighting values of the N weighting values are selected to have a predetermined value M as M=0.5*N. When M is not an integral, M can be adjusted according to different requirements. For example, the embodiment has M=0.5*3=1.5 and the predetermined value M is rounded up to 2. Therefore, based on d₁<d₂<d₃, d₁ and d₂ are selected as the sorting weighting values for M=2. In step 408, the formula

$${\overline{x}}_{M} = \frac{1}{M} {\sum }_{i = 1}^{M} {x}_{i}$$

and the formula

$${\overline{y}}_{M} = \frac{1}{M} {\sum }_{i = 1}^{M} {y}_{i}$$

can be utilized to calculate an average value of the intersectional points to be the estimated position (X_{M}, Y_{M}) of the mobile device by the corresponding sorting weighting values of the intersectional points.

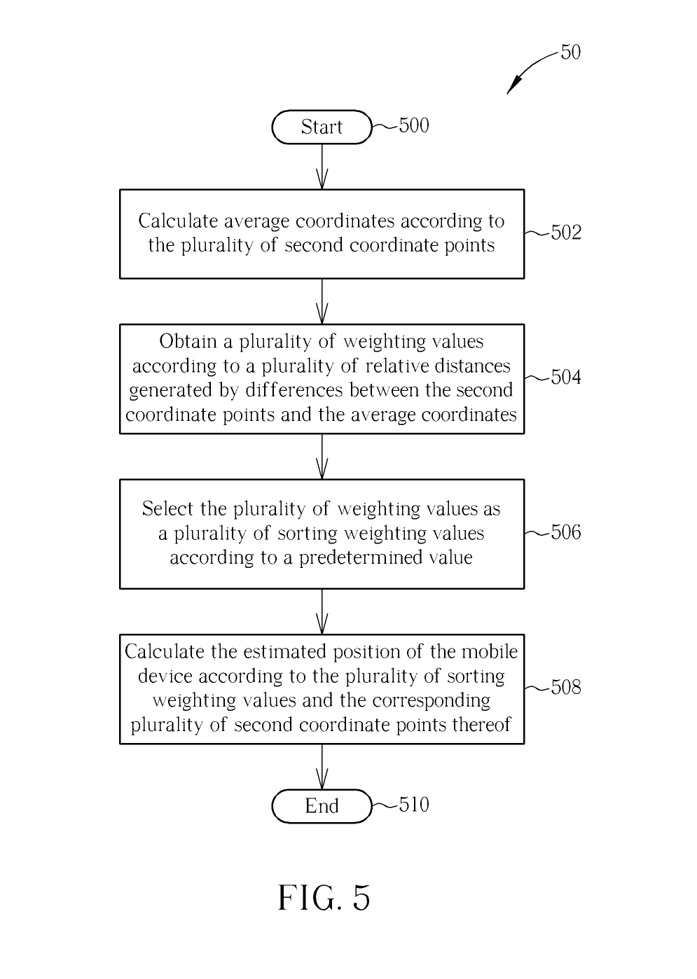

Besides, step 208 of calculating the estimated position of the mobile device according to the plurality of position lines L12, L13, L23 and the LOA L1 in the wireless communication positioning process 20 can be derived into another sort-weighted process 50 for calculating the estimated position of the mobile device. As shown in FIG. 5, the sort-weighted process 50 according to an embodiment of the invention includes the steps as follows:

Step 500: Start.

Step 502: Calculate average coordinates according to the plurality of second coordinate points.

Step 504: Obtain a plurality of weighting values according to a plurality of relative distances generated by differences between the second coordinate points and the average coordinates.

Step 506: Select the plurality of weighting values as a plurality of sorting weighting values according to a predetermined value.

Step 508: Calculate the estimated position of the mobile device according to the plurality of sorting weighting values and the corresponding plurality of second coordinate points thereof.

Step 510: End.

Noticeably, the sort-weighted process 50 is similar to the sort-averaging process 40, i.e. steps 502 to 506 of the sort-weighted process 50 are the same as steps 402 to 406 of the sort-averaging process 40. Thus, steps 502 to 506 of the sort-weighted process 50 utilize the same description of the sort-averaging process 40, which is not described hereinafter. In step 508, according to the M sorting weighting values and the M corresponding intersectional points thereof, the formulas

$$x = \frac{{\sum }_{i = 1}^{M} {( {d}_{i}^{2} )}^{- 1} \cdot {x}_{i}}{{\sum }_{i = 1}^{M} {( {d}_{i}^{2} )}^{- 1}} and y = \frac{{\sum }_{i = 1}^{M} {( {d}_{i}^{2} )}^{- 1} \cdot {y}_{i}}{{\sum }_{i = 1}^{M} {( {d}_{i}^{2} )}^{- 1}}$$

can be utilized to calculate the estimated position (X, Y) of the mobile device.

Additionally, step 208 of calculating the estimated position of the mobile device according to the plurality of position lines L12, L13, L23 and the LOA L1 in the wireless communication positioning process 20 can be derived into another threshold process 60 for calculating the estimated position of the mobile device. As shown in FIG. 5, the threshold process 60 according to an embodiment of the invention includes the steps as follows:

Step 600: Start.

Step 602: Obtain an average relative distance according to a plurality of relative distances between the plurality of second coordinate points.

Step 604: Compare the plurality of relative distances and the average relative distance to obtain the plurality of weighting values.

Step 606: Calculate the estimated position of the mobile device according to the plurality of weighting values and the plurality of second coordinate points.

Step 608: End.

In this embodiment, the threshold process 60 also takes the proper zone ZN into consideration in the wireless communication positioning process 20. For convenience, the threshold process 60 has the same assumption of the distance-weighted process 30, i.e. the second coordinate points are simply called intersectional points, the symbol N represents the total number of the intersectional points, the symbol i represents one of the intersectional points, and each of the intersectional points has the X-axis coordinate as well as the Y-axis coordinate.

In step 602, the relative distance dₘₙ between any two of the N intersectional points is calculated, wherein the symbols m and n represent the arbitrary two intersectional points of the N intersectional points with 1≦m, n≦N. Further, an average of all the relative distances dₘₙ derived from any two of N intersectional points is calculated in order to set a distance threshold Dₜₕᵣ. In step 604, a plurality of weighting values Iₘ, Iₙ corresponding to all the relative distances dₘₙ are set in advance, and the plurality of weighting values is initially set as 0. Next, all the relative distances dₘₙ and the distance threshold Dₜₕᵣ are compared to each other. If any of the relative distances dₘₙ is smaller or equal to the distance threshold Dₜₕᵣ, the weighting values Iₘ, Iₙ corresponding to the relative distance dₘₙ add 1.

In step 606, the formulas

$${x}_{t} = \frac{{\sum }_{i = 1}^{N} {I}_{i} \cdot {x}_{i}}{{\sum }_{i = 1}^{N} {I}_{i}} and {y}_{t} = \frac{{\sum }_{i = 1}^{N} {I}_{i} \cdot {y}_{i}}{{\sum }_{i = 1}^{N} {I}_{i}}$$

can be utilized to calculate the estimated position (Xₜ, Yₜ) of the mobile device according to the N intersectional points and the corresponding threshold weighting values Iᵢ thereof.

The above embodiment in the wireless communication positioning process 20 selects the plurality of intersectional points (i.e. the second coordinate points) located in the proper zone ZN as inputs the distance-weighted process 30, the sort-averaging process 40, the sort-weighted process 50 and/or the threshold process 60 in order to calculate the estimated position of the mobile device. Therefore, those skilled in the art can modify/change/combine the mentioned calculating processes and then input the plurality of intersectional points within the pooper zone ZN to the modified/changed/combined calculating processes. Besides, the plurality of first coordinate points can be directly input to the calculating processes with no limit on calculation time, all of which are also the scope of the invention.

In order to compare the prior art utilizing the Taylor series algorithm with the wireless communication positioning process 20 of the invention, three different types of simulatoin models are utilized to demonstrate the difference. In the following simulatoin models, the three base stations have their coordinate as (0, 0), (1732, 0) and (866, 1500), wherein the utilized unit is meter and ten thousands of tests are performed for each of the simulatoin models. Detail descriptions for the simulatoin models are as follows.

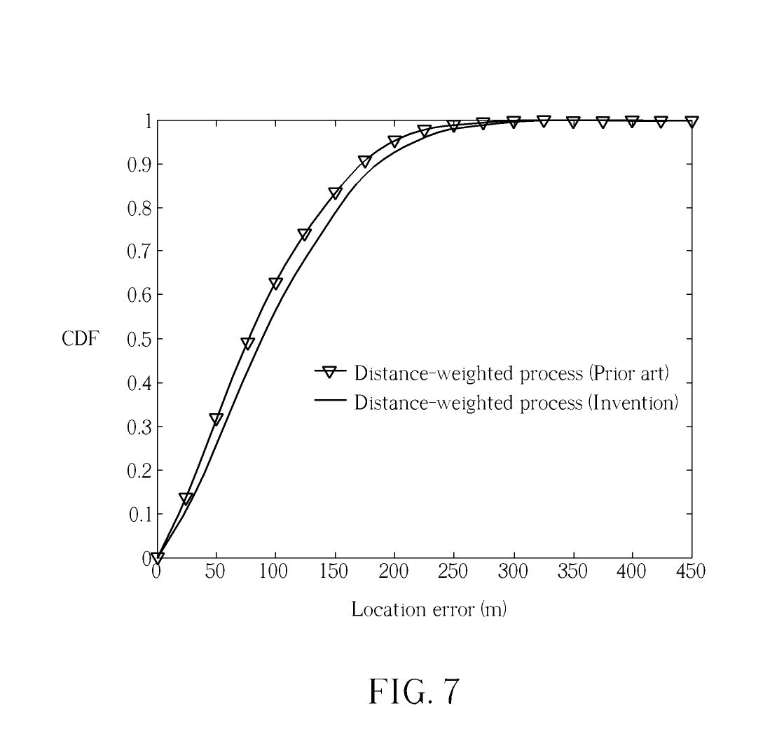

The first simulatoin model is the Circular Disk of Scatters Model (CDSM), which has a radius of a scatter point as 200 meters. In the CDSM, there exists a scatter point when the mobile device and the plurality of base stations transmit the signals to each other, and the scatter point is located within one of the measured circles of the base stations. Due to interferences of the scatter point, the TOA and the AOA measured by the plurality of base stations are different. Please refer to FIG. 7, which illustrates a schematic diagram of the Cumulative Distribution Function (CDF) which shows a difference between the prior art and a simulatoin example of the invention in the CDSM. For a simpler description, FIG. 7 depicts only the prior art (shown as the circle point) and the invention (shown as the dot point) by the distance-weighted process 30, and can be analogized to other mentioned calculating processes. As shown in FIG. 7, a smaller location error of the invention is demonstrated in comparison with the prior art, which means that the simulatoin example of the invention provides the more accurately estimated position of the mobile device.

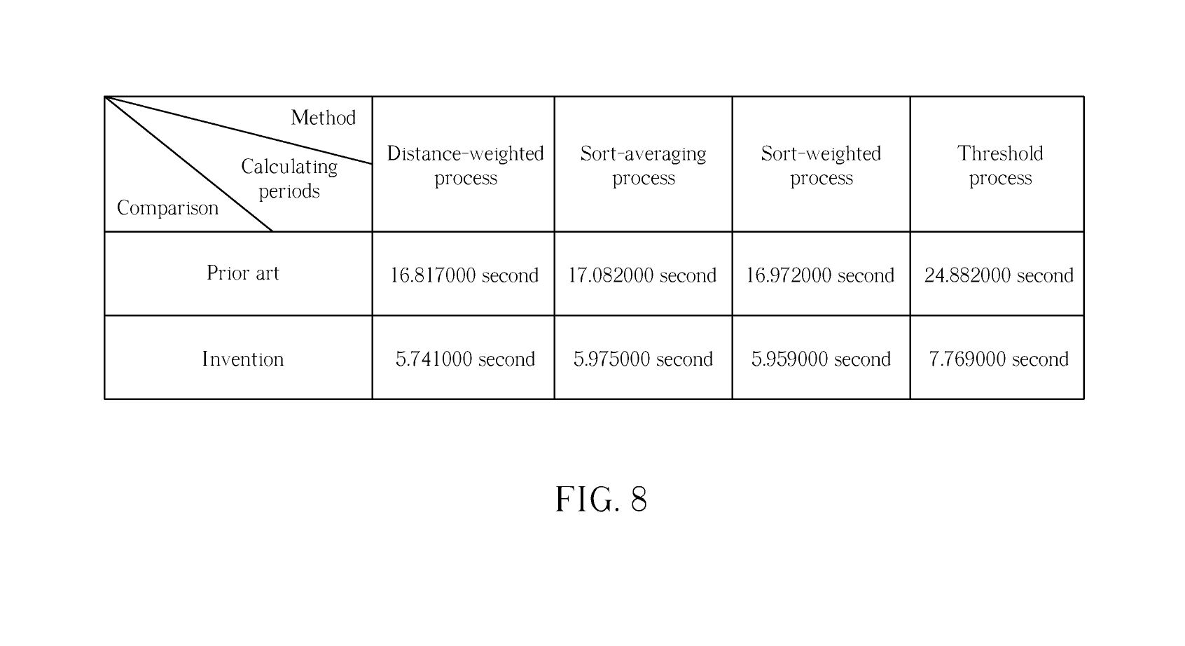

Please refer to FIG. 8, which illustrates a schematic diagram of calculating periods between the prior art and a simulatoin example of the invention in the CDSM. As shown in FIG. 8, via ten thousands tests, the invention has shorter calculating periods than the prior art and the calculating periods of the prior art can be more than three times as long as the calculating periods of the invention. In other words, this simulatoin example for calculating the estimated position of the mobile device provided by the invention is better than the prior art and effectively reduces complexity of calculation.

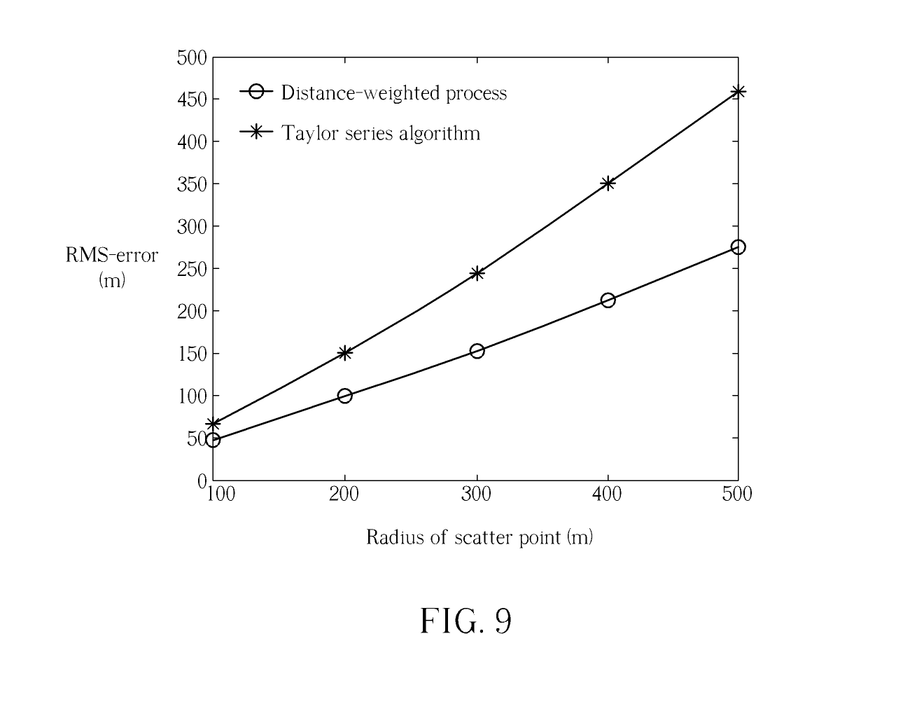

Please refer to FIG. 9, which illustrates a schematic diagram of root-mean-square (RMS) estimated positions between the prior art and a simulatoin example of the invention in the CDSM. As shown in FIG. 9, under the same radius of the scatter point, the prior art (i.e. the Taylor series algorithm) has larger RMS errors to calculate the estimated position of the mobile device than the distance-weighted process 30 of the invention. In other words, the prior art has larger errors and worse accuracy while calculating the estimated position of the mobile device.

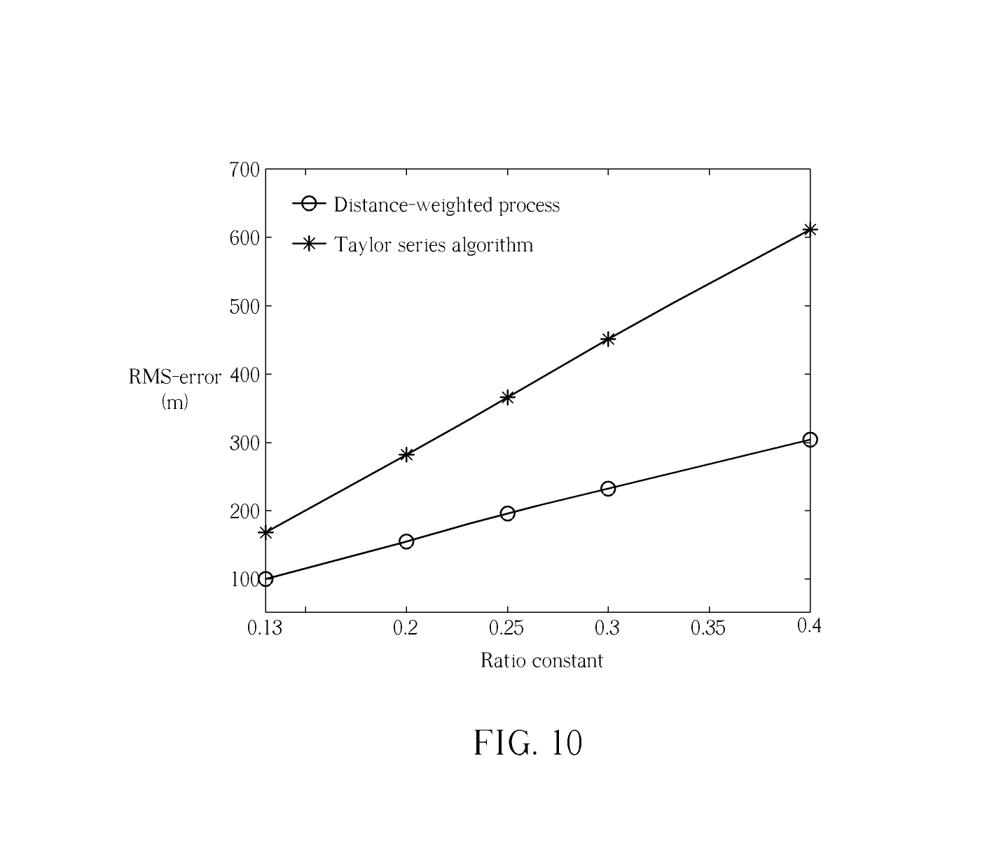

Additionally, the second simulatoin model is the distance dependent NLOS error model, which means a location error is proportional to a correct location while measuring the TOA, a ratio constant is included and the AOA is normally distributed within +/−5 degrees. Please refer to FIG. 10, which illustrates a schematic diagram of different ratio constants between the prior art and the invention in the distance dependent NLOS error model. As shown in FIG. 10, the prior art (i.e. the Taylor series algorithm) provides larger RMS errors than the distance-weighted process 30 of the invention to calculate the estimated position of the mobile device. In other words, the prior art has larger errors and worse accuracy in calculating the estimated position of the mobile device.

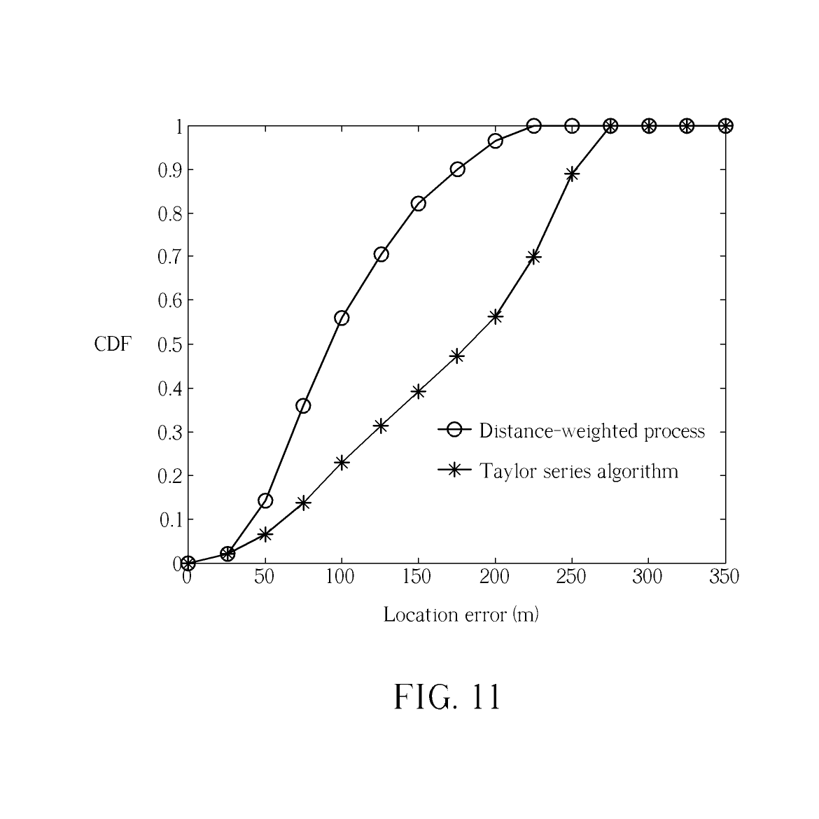

Please refer to FIG. 11, which illustrates a schematic diagram of the CDF with the ratio constants as 0.13 between the prior art and the invention in the distance dependent NLOS error model. As shown in FIG. 11, under the same possibility, the distance-weighted process 30 of the invention provides smaller location errors than does the prior art. In other words, the invention has better accuracy in calculating the estimated position of the mobile device.

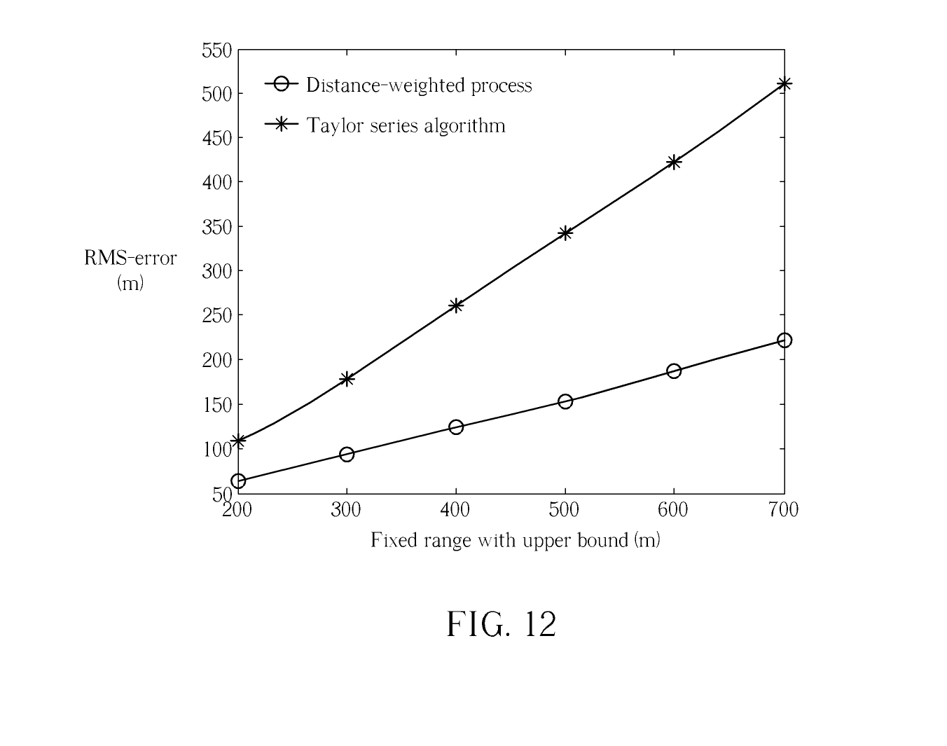

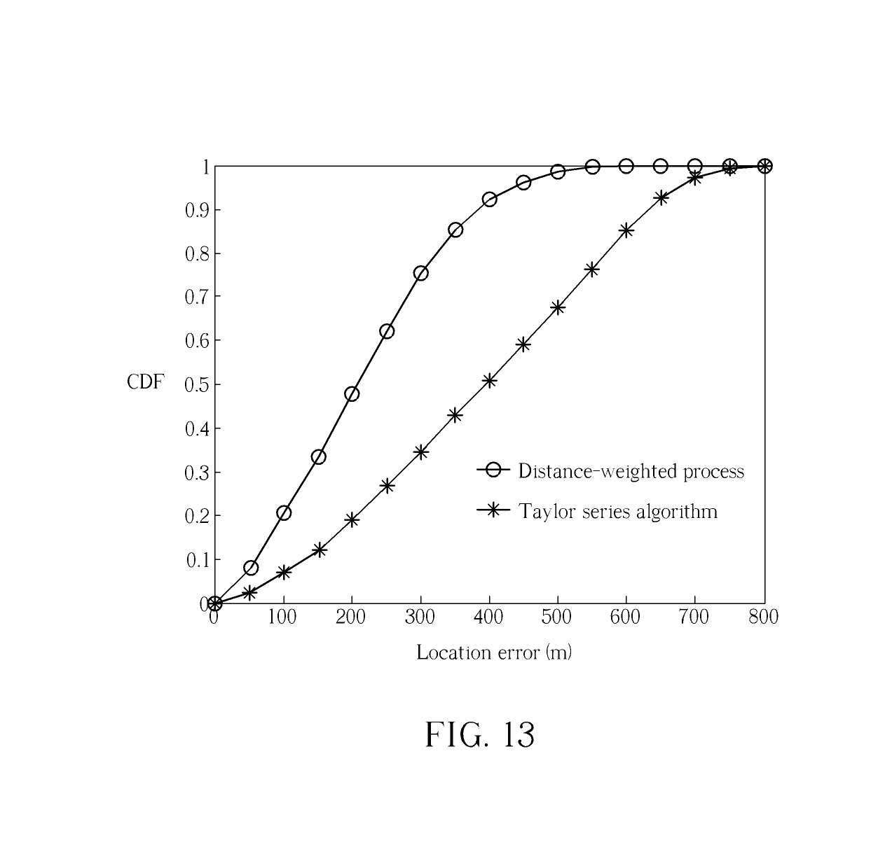

Lastly, the third simulatoin model is the normally distributed noise model, which means the TOAs of the plurality of base stations normally distribute within a fixed range, and the AOA is normally distributed within +/−5 degrees. Please refer to FIG. 12 and FIG. 13, where FIG. 12 illustrates a schematic diagram of different fixed ranges with upper bounds between the prior art and the invention in the normally distributed noise model, and FIG. 13 illustrates a schematic diagram of the CDF of the fixed range with upper bound between the prior art and the invention in the normally distributed noise model. Similar to analysis results of the second simulatoin model, as shown in FIG. 12 and FIG. 13, the simulatoin example of the invention provides better accuracy than does the prior art while calculating the estimated position of the mobile device, which is not narrated hereinafter.

As with the above description, according to the analysis results of the three simulatoin models, the embodiment utilizing the distance-weighted method of the invention effectively reduces the calculating complexity (i.e. having shorter calculating periods) and calculates the estimated position of the mobile device with more accuracy (i.e. having smaller location errors) in comparison with the Taylor series algorithm of the prior art. Similarly, the above analysis results can be found in the sort-averaging method, the sort-weighted method and the threshold method, so as to comply with different requirements and pursuit of more efficient and accurate estimation.

Noticeably, please refer to FIG. 1B again. The above calculating processes applying to the embodiment of the invention can also be applied to the wireless communication positioning system 12 including the seven base stations BS1-BS7. In detail, the seven TOAs corresponding to the seven base stations BS1-BS7 are measured to obtain seven measured distances and seven measured circles. In this situation, the seven measured circles generate at most 21 position lines. Besides, it also obtains the AOA and LOA corresponding to one of the base stations BS1-BS7. Lastly, according to the plurality of position lines generated by the base stations BS1-BS7 and the LOA, a limitation condition as one proper zone can be added to calculate the estimated position of the mobile device. The proper zone can also be the intersection zone of the seven measured circles, or be another intersection zone which has the most measured circles intersecting with each other if all the seven measured circles cannot intersect within the same area at the same time. More detail descriptions of the steps can be referred to by the wireless communication positioning process 20 as well as the wireless communication positioning system 10, which are not described hereinafter.

Noticeably, please refer to FIG. 1A with three base stations and FIG. 1B with seven base stations again, which helps comprehension of the difference of calculating the estimated position of the mobile device in wireless communication systems with different numbers of base stations. For the case of the three base stations, it has more accuracy with solutions of circle intersection points, and, nevertheless, the corresponding calculation is more complex. On the other hand, by utilizing the plurality of position lines, it provides less accuracy but less complex calculation.

Additionally, for the case with the seven base stations, it is more complex with solutions of circle intersection points, and although less intersectional points are required, poorer accuracy are generated. On the other hand, by utilizing the plurality of position lines, the calculation is less complex, and although more intersectional points are generated, higher estimation accuracy can be obtained by combining the proper zone as an effective filter, such as the intersection zone of the seven circles. From the above comparison with different numbers of base stations, the user can flexibly choose solutions of circle intersection points or the position lines, with an selected usage of the proper zone. Additionally, the user can combine/change the above conditions to provide another calculating process in pursuit of better accuracy as well as less complexity. All is within the scope of the invention.

In summary, the embodiments provide a wireless communication positioning method for a wireless communication positioning system. A plurality of base stations provide a plurality of position lines and a line of arrival angle (LOA), and a plurality of intersectional points are obtained under the above conditions. Next, the plurality of intersectional points input a distance-weighted method, a sort-averaging method, a sort-weighted method and/or a threshold method to calculate an estimated position of the mobile device. Besides, by utilizing a proper zone, redundant intersectional points can be excluded to increase accuracy as well as to reduce calculating periods. Thus, in comparison with the prior art which utilizes the Taylor series algorithm to solve circle intersection points with complex calculating formulas and longer calculating periods, the embodiments of the invention can effectively reduce the calculating complexity to provide smaller location errors, and effectively save calculating periods of implemented hardware resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication positioning method for obtaining an estimated position of a mobile device, the method comprising:
obtaining an angle of arrival for the mobile device relative to one of a plurality of base stations and obtaining a line of arrival angle extended along the angle of arrival from the one of the plurality of base stations;
obtaining a plurality of measured distances of the plurality of base stations relative to the mobile device and obtaining a plurality of measured circles corresponding to the plurality of measured distances;
generating a plurality of position lines according to the plurality of measured circles; and
calculating the estimated position of the mobile device according to the plurality of position lines and the line of arrival angle.

2. The wireless communication positioning method of claim 1, wherein the step of generating the plurality of position lines according to the plurality of measured circles comprises:
connecting pairs of intersectional points of any two of the measured circles to generate the plurality of position lines.

3. The wireless communication positioning method of claim 1, wherein the step of calculating the estimated position of the mobile device according to the plurality of position lines and the line of arrival angle comprises:
generating a plurality of first coordinate points according to the plurality of position lines and the line of arrival angle; and
calculating the estimated position of the mobile device according to the plurality of first coordinate points.

4. The wireless communication positioning method of claim 3, wherein the step of calculating the estimated position of the mobile device according to the plurality of first coordinate points comprises:
generating a proper zone according to an intersection zone of the measured circles;
choosing from the plurality of first coordinate points located within the intersection zone as a plurality of second coordinate points; and
calculating the estimated position of the mobile device according to the plurality of second coordinate points.

5. The wireless communication positioning method of claim 4, wherein a distance-weighted method, a sort-averaging method, a sort-weighted method or a threshold method is utilized to calculate the estimated position of the mobile device according to the plurality of second coordinate points.

6. The wireless communication positioning method of claim 4, wherein the step of calculating the estimated position of the mobile device according to the plurality of second coordinate points comprises:
calculating average coordinates according to the plurality of second coordinate points;
obtaining a plurality of weighting values according to a plurality of relative distances generated by differences between the second coordinate points and the average coordinates; and
calculating the estimated position of the mobile device according to the plurality of weighting values and the plurality of second coordinate points.

7. The wireless communication positioning method of claim 4, wherein the step of calculating the estimated position of the mobile device according to the plurality of second coordinate points comprises:
calculating an average relative distance according to a plurality of relative distances between the plurality of second coordinate points;
comparing individually the plurality of relative distances with the average relative distance to obtain a plurality of weighting values; and
calculating the estimated position of the mobile device according to the plurality of weighting values and the plurality of second coordinate points.

8. The wireless communication positioning method of claim 1, wherein the line of arrival angle is obtained via extending the angle of arrival from the one of the plurality of base stations.

9. The wireless communication positioning method of claim 1, wherein the step of obtaining the plurality of measured distances of the plurality of base stations relative to the mobile device comprises:
obtaining a plurality of time points of arrival from the plurality of base stations to the mobile device respectively; and
generating a plurality of measured distances corresponding to the plurality of base stations according to the plurality of time points of arrival.

10. The wireless communication positioning method of claim 1, wherein the plurality of base stations are three base stations, which correspond to three time points of arrival, three measured circles and three position lines.

11. The wireless communication positioning method of claim 1, wherein the plurality of base stations are seven base stations, which correspond to seven time points of arrival, seven measured circles and twenty one position lines.

12. The wireless communication positioning method of claim 1, wherein the base station obtaining the line of arrival angle is the nearest base station to the mobile device.

13. The wireless communication positioning method of claim 4, wherein the step of generating the proper zone according to the intersection zone of the measured circles comprises:
choosing an area where the greatest plurality of measured circles mutually cross as the intersection zone if all the plurality of measured circles cannot mutually cross.

14. A wireless communication positioning method for obtaining an estimated position of a mobile device, the method comprising:
obtaining a line of arrival angle which extends to pass through one of a plurality of base stations and the mobile device;
obtaining a plurality of measured circles corresponding to the plurality of base stations, each of the measured circles is generated by a plurality of measured distances of the plurality of base stations relative to the mobile device;
generating a plurality of position lines according to the plurality of measured circles; and
calculating the estimated position of the mobile device according to the plurality of position lines and the line of arrival angle.

15. The wireless communication positioning method of claim 14, wherein the step of generating the plurality of position lines according to the plurality of measured circles comprises:
connecting two intersectional points of any two of the measured circles to generate the plurality of position lines.

16. The wireless communication positioning method of claim 14, wherein the step of calculating the estimated position of the mobile device according to the plurality of position lines and the line of arrival angle comprises:
generating a plurality of first coordinate points according to the plurality of position lines and the line of arrival angle; and
calculating the estimated position of the mobile device according to the plurality of first coordinate points.

17. The wireless communication positioning method of claim 16, wherein the step of calculating the estimated position of the mobile device according to the plurality of first coordinate points comprises:
generating a proper zone according to a intersection zone of the measured circles;
choosing from the plurality of first coordinate points locating within the intersection zone as a plurality of second coordinate points; and
calculating the estimated position of the mobile device according to the plurality of second coordinate points.

18. The wireless communication positioning method of claim 14, wherein the base station obtaining the line of arrival angle is the nearest base station to the mobile device.
